(19) United States
(12) Patent Application Publication
(10) Pub. No.: US 2015/0203630 A1
(43) Pub. Date: Jul. 23, 2015

(54) Polyesters

(71) Applicant: CLARIANT INTERNATIONAL LTD, Muttenz (CH)

(72) Inventors: Dirk Fischer, Klein-Winternheim (DE); Thomas Lindner, Wiesbaden (DE)

(73) Assignee: CLARIANT FINANCE (BVI) LIMITED, Tortola (VG)

(21) Appl. No.: 14/418,703

(22) PCT Filed: Jul. 24, 2013
(86) PCT No.: PCT/EP2013/002195

§ 371 Date: Jan. 30, 2015

(30) Foreign Application Priority Data
Jul. 31, 2012 (EP) 12005550.4

(51) Int. Cl. C08G 63/66; C08G 63/78

(52) U.S. Cl. CPC C08G 63/66; C08G 63/78

(57) ABSTRACT

Polyesters according to the following formula (I) are described

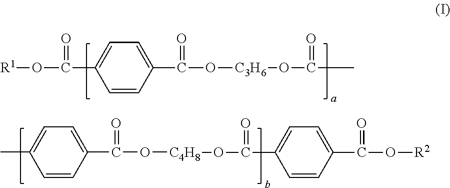

wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group or are HO—(C₃H₆) or HO—(C₄H₈),
n is based on a molar average a number of from 40 to 50,
m is based on a molar average a number of from 1 to 7, and
a+b is based on a molar average a number of from 4 to 9.

The polyesters have an advantageous stability in alkaline environment, possess a beneficial solubility and advantageously are clearly soluble in alkaline compositions such as alkaline heavy duty washing liquids and also possess advantageous soil release properties.

The invention relates to new polyesters and a process for their preparation. The polyesters are useful as soil release agents in laundry detergent and fabric care products.

The term “soil release agent” is applied to materials that modify the fabric surface minimizing the subsequent soiling and making the cleaning of the fabric easier on further washing cycles.

Laundry detergent compositions containing polyesters have been widely disclosed in the art.

DE 10 2007 013 217 A1 and WO 2007/079850 A1 disclose anionic polyesters that may be used as soil release components in washing and cleaning compositions.

DE 10 2007 005 532 A1 describes aqueous formulations of soil release oligo- and polyesters with a low viscosity. The aqueous formulations may e.g. be used in washing and cleaning compositions.

EP 0 964 015 A1 discloses soil release oligoesters that may be used as soil release polymers in detergents and that are prepared using polyols comprising 3 to 6 hydroxyl groups.

EP 1 661 933 A1 is directed to at room temperature flowable, amphiphilic and nonionic oligoesters prepared by reacting dicarboxylic acid compounds, polyol compounds and water-soluble alkylene oxide adducts and their use as additive in washing and cleaning compositions.

However, many of the polyesters described in the prior art are in need of improved stability in an alkaline environment. Especially in alkaline heavy duty washing liquids polyesters often show turbidity upon incorporation and by alkaline hydrolysis thereby also losing soil release power.

Therefore, it was the object of the present invention to provide new polyesters which have an advantageous stability in alkaline environment, possess a beneficial solubility and advantageously are clearly soluble in alkaline compositions such as alkaline heavy duty washing liquids and also possess advantageous soil release properties.

Surprisingly this object is solved by polyesters according to the following formula (I)

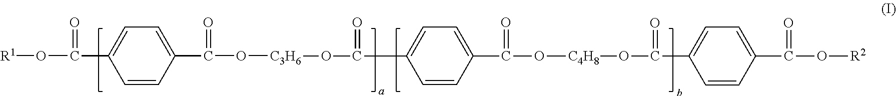

wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group or are HO—(C₃H₆) or HO—(C₄H₈),
n is based on a molar average a number of from 40 to 50,
m is based on a molar average a number of from 1 to 7, and
a+b is based on a molar average a number of from 4 to 9.

Therefore, a subject matter of the present invention are polyesters according to the following formula (I)

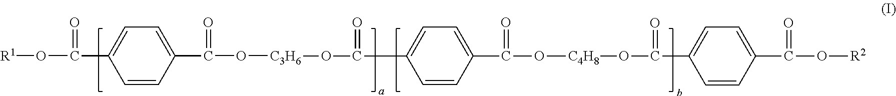

wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group or are HO—(C₃H₆) or HO—(C₄H₈),
n is based on a molar average a number of from 40 to 50,
m is based on a molar average a number of from 1 to 7, and
a+b is based on a molar average a number of from 4 to 9.

In these inventive polyesters wherein the sum “a+b” based on a molar average is a number of from 4 to 9, the variable “a” based on a molar average preferably is a number of from 2.8 to 8.1 and the variable “b” based on a molar average preferably is a number of from 0.4 to 2.7.

In the inventive polyesters the sum “a+b” based on a molar average preferably is a number of from 5 to 8.

In these preferred inventive polyesters wherein the sum “a+b” based on a molar average is a number of from 5 to 8, the variable “a” based on a molar average preferably is a number of from 3.5 to 7.2 and the variable “b” based on a molar average preferably is a number of from 0.5 to 2.4.

In the inventive polyesters the sum “a+b” based on a molar average more preferably is a number of from 6 to 7.

In these preferred inventive polyesters wherein the sum “a+b” based on a molar average is a number of from 6 to 7, the variable “a” based on a molar average preferably is a number of from 4.2 to 6.3 and the variable “b” based on a molar average preferably is a number of from 0.6 to 2.1. Among these inventive polymers those polymers are preferred wherein the variable “a” based on a molar average is a number of from 4.8 to 5.6 and the variable “b” based on a molar average is a number of from 1.2 to 1.4.

In the inventive polyesters variable “m” based on a molar average preferably is a number of from 2 to 5 and more preferably is 3.

In the inventive polyesters the variable “n” based on a molar average preferably is a number of from 43 to 47, more preferably is a number of from 44 to 46 and even more preferably is 45.

Inventive polyesters according to formula (I)

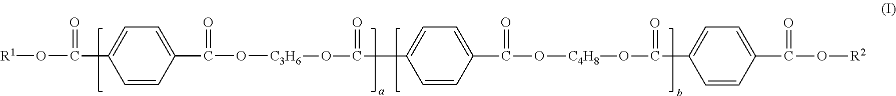

wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is based on a molar average a number of from 44 to 46,
m is based on a molar average 3, and
a+b is based on a molar average a number of from 5 to 8 are particularly preferred.

Among these particularly preferred inventive polyesters the polyesters wherein the variable “a” based on a molar average is a number of from 3.5 to 7.2 and the variable “b” based on a molar average is a number of from 0.5 to 2.4 are preferred.

Inventive polyesters according to formula (I)

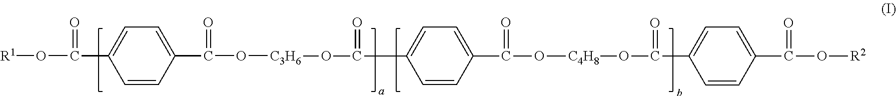

wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is based on a molar average a number of from 44 to 46,
m is based on a molar average 3, and
a+b is based on a molar average a number of from 6 to 7 are especially preferred.

Among these especially preferred inventive polyesters the polyesters wherein the variable “a” based on a molar average is a number of from 4.2 to 6.3 and the variable “b” based on a molar average is a number of from 0.6 to 2.1 are preferred.

In the above-mentioned particularly preferred and especially preferred inventive polyesters the variable “n” based on a molar average preferably is 45.

Inventive polyesters according to formula (I)

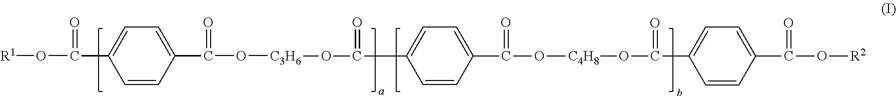

wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is based on a molar average 45,
m is based on a molar average 3,
a+b is based on a molar average a number of from 6 to 7,
a based on a molar average is a number of from 4.8 to 5.6, and
b based on a molar average is a number of from 1.2 to 1.4 are extraordinarily preferred.

In the inventive polyesters the molar ratio of structural units indexed with “a”: structural units indexed with “b” preferably is of from 70:30 to 90:10 and more preferably is 80:20.

In the inventive polyesters the structural units indexed with “a” and the structural units indexed with “b” preferably are distributed blockwise, alternating or statistically and more preferably are distributed statistically.

The groups —O—C₂H₄—in the structural units “H₃C—(OC₂H₄)ₙ—(OC₃H₆)ₘ” are of the formula —O—CH₂—CH₂—.

The groups —O—C₃H₆—in the structural units indexed with “a”, in the structural units “H₃C—(OC₂H₄)ₙ—(OC₃H₆)ₘ” and in the structural units HO—(C₃H₆) are of the formula —O—CH(CH₃)—CH₂—or —O—CH₂—CH(CH₃)—, i.e. are of the formula

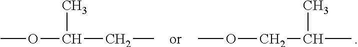

The groups —O—C₄H₈—in the structural units indexed with “b” and in the structural units HO—(C₄H₈) are of the formula —O—CH(CH₃)—CH(CH₃)—, i.e. are of the formula

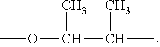

The inventive polyesters may be used in substance, i.e. as such, but may also be provided as aqueous solutions. The aqueous solutions are e.g. beneficial with respect to their handling and e.g. the metering of the inventive polyester is very easy. Preferably, the aqueous solutions comprise the inventive polyesters in an amount of from 25 to 70 weight-% based on the total mass of the aqueous solution.

Therefore, a further subject matter of the invention is an aqueous solution comprising an inventive polyester in an amount of from 25 to 70 weight-% based on the total mass of the aqueous solution. These aqueous solutions may even consist of the inventive polyester and water.

The inventive polyesters may advantageously be used in washing or laundry detergent compositions. Besides the inventive polyesters these washing or laundry detergent compositions may comprise one or more optional ingredients, e.g. they may comprise conventional ingredients commonly used in laundry detergent compositions. Examples of optional ingredients include, but are not limited to builders, surfactants, bleaching agents, bleach active compounds, bleach activators, bleach catalysts, photobleaches, dye transfer inhibitors, color protection agents, anti-redeposition agents, dispersing agents, fabric softening and antistatic agents, fluorescent whitening agents, enzymes, enzyme stabilizing agents, foam regulators, defoamers, malodour reducers, preservatives, disinfecting agents, hydrotopes, fibre lubricants, anti-shrinkage agents, buffers, fragrances, processing aids, colorants, dyes, pigments, anti-corrosion agents, fillers, stabilizers and other conventional ingredients for washing or laundry detergent compositions.

The inventive polyesters have an advantageous stability in alkaline environment, possess a beneficial solubility and advantageously are clearly soluble in alkaline compositions such as alkaline heavy duty washing liquids and also possess advantageous soil release properties. In washing or laundry detergent compositions they result in a beneficial washing performance, in particular also after storage. Furthermore, the inventive polyesters possess advantageous foam suppressing properties. This is not only advantageous when the washing or laundry detergent compositions comprising the inventive polyesters are applied but also advantageously reduces foaming during handling of the inventive polyesters.

The inventive polyesters may advantageously be prepared by a process which comprises heating dimethyl terephthalate (DMT), 1,2-propylene glycol (PG), 2,3-butylene glycol (BG), and H₃C—(OC₂H₄)ₙ—(OC₃H₆)ₘ—OH, wherein the —(OC₂H₄) groups and the —(OC₃H₆) groups are arranged blockwise and the block consisting of the —(OC₃H₆) groups is bound to the hydroxyl group —OH and n and m are as defined for the inventive polyesters, with the addition of a catalyst, to temperatures of from 160 to 220° C., firstly at atmospheric pressure, and then continuing the reaction under reduced pressure at temperatures of from 160 to 240° C.

Therefore, a further subject matter of the invention is a process for the preparation of the inventive polyesters which comprises heating dimethyl terephthalate (DMT), 1,2-propylene glycol (PG), 2,3-butylene glycol (BG) and H₃C—(OC₂H₄)ₙ-(OC₃H₆)ₘ—OH, wherein the —(OC₂H₄) groups and the —(OC₃H₆) groups are arranged blockwise and the block consisting of the —(OC₃H₆) groups is bound to the hydroxyl group —OH and n and m are as defined for the inventive polyesters, with the addition of a catalyst, to temperatures of from 160 to 220° C., firstly at atmospheric pressure, and then continuing the reaction under reduced pressure at temperatures of from 160 to 240° C.

Reduced pressure preferably means a pressure of from 0.1 to 900 mbar and more preferably a pressure of from 0.5 to 500 mbar.

In a preferred embodiment of the invention the inventive process is characterized in that

a) dimethyl therephthalate, 1,2-propylene glycol, 2,3-butylene glycol, H₃C—(OC₂H₄)ₙ—(OC₃H₆)ₘ—OH and a catalyst are added to a reaction vessel, heated under inert gas, preferably nitrogen, to a temperature of from 160° C. to 220° C. to remove methanol and then pressure is reduced to below atmospheric pressure, preferably to a pressure of from 200 to 900 mbar and more preferably to a pressure of from 400 to 600 mbar for completion of the transesterification, and
b) in a second step the reaction is continued at a temperature of from 210° C. to 240° C. and at a pressure of from 0.1 to 10 mbar and preferably of from 0.5 to 5 mbar to form the polyester.

Sodium acetate (NaOAc) and tetra isopropyl orthotitanate (IPT) is preferably used as the catalyst system in the inventive process.

The examples below are intended to illustrate the invention in detail without, however, limiting it thereto. unless explicitly stated otherwise, all percentages given are percentages by weight (% by wt. or wt.-%).

General Procedure for the Preparation of the Inventive Polyesters

The polyester synthesis is carried out by the reaction of dimethyl terephthalate (DMT), 1,2-propylene glycol (PG), 2,3-butylene glycol (BG) and methyl polyalkyleneglycol using sodium acetate (NaOAc) and tetraisopropyl orthotitanate (IPT) as the catalyst system. The synthesis is a two-step procedure. The first step is a transesterification and the second step is a polycondensation.

Transesterification

Dimethyl terephthalate (DMT), 1,2-propylene glycol (PG), 2,3-butylene glycol (BG), methyl polyalkyleneglycol, sodium acetate (anhydrous) (NaOAc) and tetraisopropyl orthotitanate (IPT) are weighed into a reaction vessel at room temperature.

For the melting process and homogenization, the mixture is heated up to 170° C. for 1 h and then up to 210° C. for a further 1 h sparged by a nitrogen stream. During the transesterification methanol is released from the reaction and is distilled out of the system (distillation temperature<55° C.). After 2 h at 210° C. nitrogen is switched off and the pressure is reduced to 400 mbar over 3 h.

Polycondenzation

The mixture is heated up to 230° C. At 230° C. the pressure is reduced to 1 mbar over 160 min. Once the polycondensation reaction has started, a 1,2-propylene glycol/2,3-butylene glycol mixture is distilled out of the system. The mixture is stirred for 4 h at 230° C. and a pressure of 1 mbar. The reaction mixture is cooled down to 140-150° C. Vacuum is released with nitrogen and the molten Polymer is transferred into a glass bottle.

### Example I:

| Amount | Amount | Raw Material |
|---|---|---|
| [g] | [mol] | [Abbreviation] |
| 97.1 | 0.50 | DMT |
| 18.02 | 0.2 | BG |
| 60.88 | 0.8 | PG |
| 310.56 | 0.145 | H₃C—(OC₂H₄)₄₅—(OC₃H₆)₃—OH |
| 0.5 | 0.0061 | NaOAc |
| 0.2 | 0.0007 | IPT |

An inventive polyester according to formula (I) is obtained wherein

R¹ and R² are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is based on a molar average 45,
m is based on a molar average 3, and
a+b is based on a molar average a number of from 6 to 7,
a based on a molar average is a number of from 4.8 to 5.6, and
b based on a molar average is a number of from 1.2 to 1.4.

1. A polyester according to formula (I) 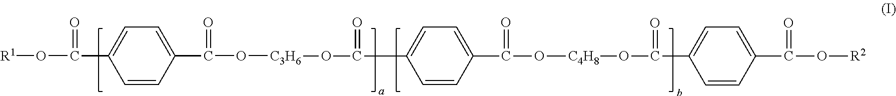
wherein
R¹ and R² independently of one another are H₃C—(OC₂H₄—(OC₃H₆)ₘ wherein the —(OC₂H₄) groups and the —(OC₃H₆) groups are arranged blockwise and the block consisting of the —(OC₃H₆) groups is bound to a COO group or are HO—(C₃H₆) or HO—(C₄H₈),
n is a number of from 40 to 50,
m is a number of from 1 to 7, and
a+b is a number of from 4 to 9,
wherein n, m, and a+b are based on a molar average.

2. The polyester according to claim 1, wherein a is a number of from 2.8 to 8.1 and b is a number of from 0.4 to 2.7.

3. The polyester according to claim 1, wherein the sum a+b is a number of from 5 to 8.

4. The polyester according to claim 3, wherein a is a number of from 3.5 to 7.2 and b is a number of from 0.5 to 2.4.

5. The polyester according to claim 1, wherein the sum a+b is a number of from 6 to 7.

6. The polyester according to claim 5, wherein a is a number of from 4.2 to 6.3 and b is a number of from 0.6 to 2.1.

7. The polyester according to claim 5, wherein a is a number of from 4.8 to 5.6 and b is a number of from 1.2 to 1.4

8. The polyester according to claim 1, wherein m is a number of from 2 to 5.

9. The polyester according to claim 8, wherein m is 3.

10. The polyester according to claim 1, wherein n is a number of from 43 to 47.

11. The polyester according to claim 10, wherein n is a number of from 44 to 46.

12. The polyester according to claim 11, wherein n is 45.

13. The polyester according to claim 1, wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is a number of from 44 to 46,
m is 3, and
a+b is a number of from 5 to 8.

14. The polyester according to claim 13, wherein a is a number of from 3.5 to 7.2 and b is a number of from 0.5 to 2.4.

15. The polyester according to claim 13, wherein
R¹ and R² independently of one another are H₃C—(OC₂H₄)ₙ—(OC₃H₆)ₘ wherein the —(OC₂H₄) groups and the —(OC₃H₆) groups are arranged blockwise and the block consisting of the —(OC₃H₆) groups is bound to a COO group,
n is a number of from 44 to 46,
m is 3, and
a+b is a number of from 6 to 7.

16. The polyester according to claim 15, wherein a is a number of from 4.2 to 6.3 and b is a number of from 0.6 to 2.1.

17. The polyester according to claim 13, wherein n is 45.

18. The polyester according to claim 1, wherein
R¹ and R² independently of one another are H₃C—(OC₂H₄)ₙ—(OC₃H₆)_{M} wherein the —(OC₂H₄) groups and the —(OC₃H₆) groups are arranged blockwise and the block consisting of the —(OC₃H₆) groups is bound to a COO group,
n is 45,
m is 3,
a+b is a number of from 6 to 7,
a is a number of from 4.8 to 5.6, and
b is a number of from 1.2 to 1.4.

19. The polyester according to claim 1, wherein the molar ratio of structural units a to structural units b is of from 70:30 to 90:10.

20. The polyester according to claim 1, wherein the molar ratio of structural units a to structural units b is 80:20.

21. The polyester according to claim 1, wherein the structural units a and the structural units b are distributed blockwise, alternating or statistically.

22. The polyester according to claim 21, wherein the structural units a and the structural units b are distributed statistically.

23. A process for the preparation of a polyester according to claim 1, comprising the step of heating dimethyl terephthalate, 1,2-propylene glycol, 2,3-butylene glycol, and H₃C—(OC₂H₄)ₙ—(OC₃H₆)ₘ—OH, wherein the —(OC₂H₄) groups and the —(OC₃H₆) groups are arranged blockwise and the block consisting of the —(OC₃H₆) groups is bound to the hydroxyl group —OH and n and m are as defined in claim 1, with the addition of a catalyst, to temperatures of from 160 to 220° C., firstly at atmospheric pressure, and then continuing the reaction under reduced pressure at temperatures of from 160 to 240° C.
